(19) United States
(12) Patent Application Publication
(10) Pub. No.: US 2007/0151115 A1
(43) Pub. Date: Jul. 5, 2007

(54) Close quarter hack saw

(75) Inventor: Qiu Jian Ping, Hangzhou (CN)

Correspondence Address: WILLIAM COLLARD;COLLARD & ROE, P.C., 1077 NORTHERN BOULEVARD, ROSLYN, NY, 11576, US

(73) Assignee: Great Neck Saw Manufacturers, Inc.

(21) Appl. No.: 11/320,991

(22) Filed: Dec. 29, 2005

(51) Int. Cl. B27B 21/00

(52) U.S. Cl. 30/517

(57) ABSTRACT

A hack saw having a blade receiving assembly and a blade guide assembly, one blade guide assembly is movable relative to the blade receiving assembly and is adapted to receive a blade movably mounted therein. The blade receiving assembly has first lock means to lock said blade relative to the blade receiving assembly and second lock means to lock said blade guide assembly relative to the blade receiving assembly.

### BACKGROUND

The present invention relates to a hack saw and more particularly to a close quarter hack saw which has a replaceable blade.

Close quarter hack saws have been known for a number of years. They consist of a frame in the form of a handle with a hack saw blade mounted on and extending from the front of the handle. However, some of such close quarter hacksaws may not easily be used for effective close quarter work. In others the blade may not be easily adjusted relative to the handle and/or may not be easily replaced. In addition, some of such close quarter hack saws are expensive and complicated to manufacture and/or are difficult to use.

Objects

The present invention overcomes these difficulties and has for one of its objects the provision of an improved close quarter hack saw which may be easily used for close quarter work.

Another object of the present invention is the provision of an improved close quarter hack saw in which the blade may be easily removed.

Another object of the present invention is the provision of an improved close quarter hack saw in which the blade may be easily adjusted relative to the handle.

Another object of the present invention is an improved hack saw which is simple to use.

Another object of the present invention is an improved hack saw which is simple and inexpensive to manufacture and assemble.

Other and further objects of the invention will be obvious upon an understanding of the illustrative embodiment about to described, or will be indicated in the appended claims and various advantages not referred to herein will occur to one skilled in the art upon employment of the invention in practice.

### DRAWINGS

A preferred embodiment of the invention has been chosen for purposes of illustration and description and is shown in the accompanying drawings forming a part of the specification, wherein:

FIG. 1 is a perspective view showing the close quarter hack saw of the present invention.

FIG. 2 is an exploded perspective view of the close quarter hack saw of the present invention.

FIG. 3 is an exploded plan view of the present invention partly in section.

FIG. 4 is a sectional view taken along lines 4-4 of FIG. 1.

FIG. 5 is a sectional view taken along line 5-5 of FIG. 4.

FIG. 6 is a sectional view taken along line 6-6 of FIG. 4.

FIG. 7 is a side view, partly in section, showing the manner of locking the blade in place in one position.

FIG. 8 is a side view similar to FIG. 7 showing the manner of holding the blade in place in another position.

FIG. 9 is a side view similar to FIG. 7 showing the blade being removed.

FIG. 10 is a detail of one of the parts.

FIG. 11 is a top view, partly in section of the blade holder.

FIG. 12 is a sectional side view thereof.

FIG. 13 is a top view of the blade holder.

FIG. 14 is a side view of the blade holder.

FIG. 15 is a rear end view of the blade holder.

FIG. 16 is front end view of the blade holder.

FIG. 17 is a sectional detail of one of the parts.

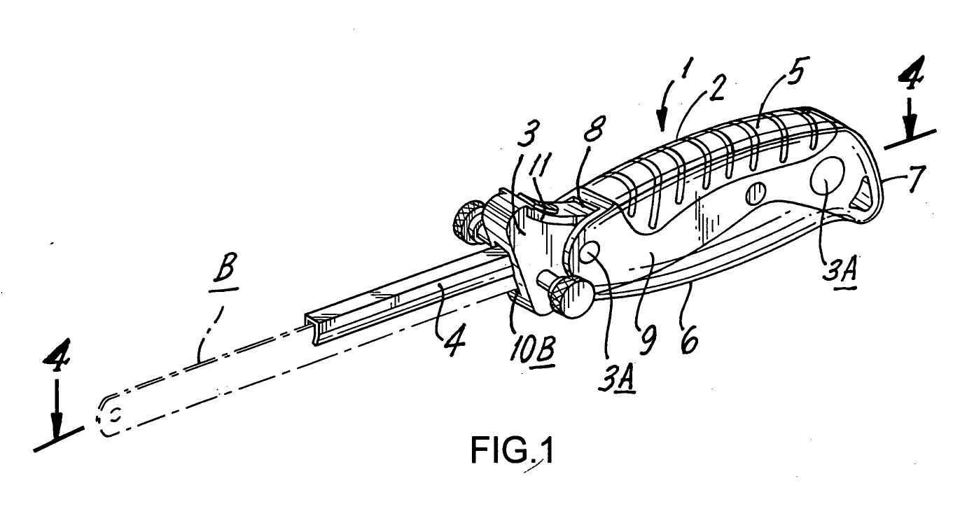

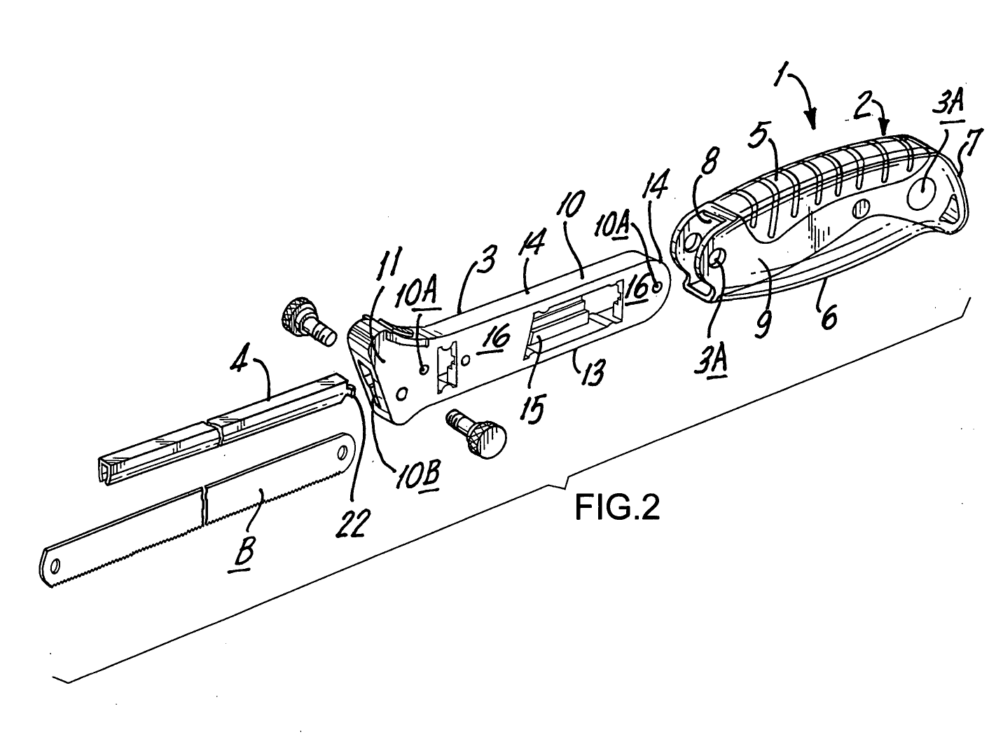

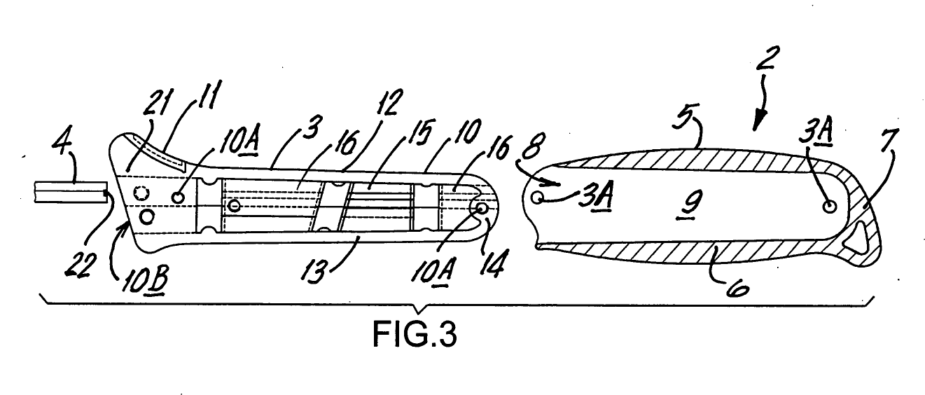

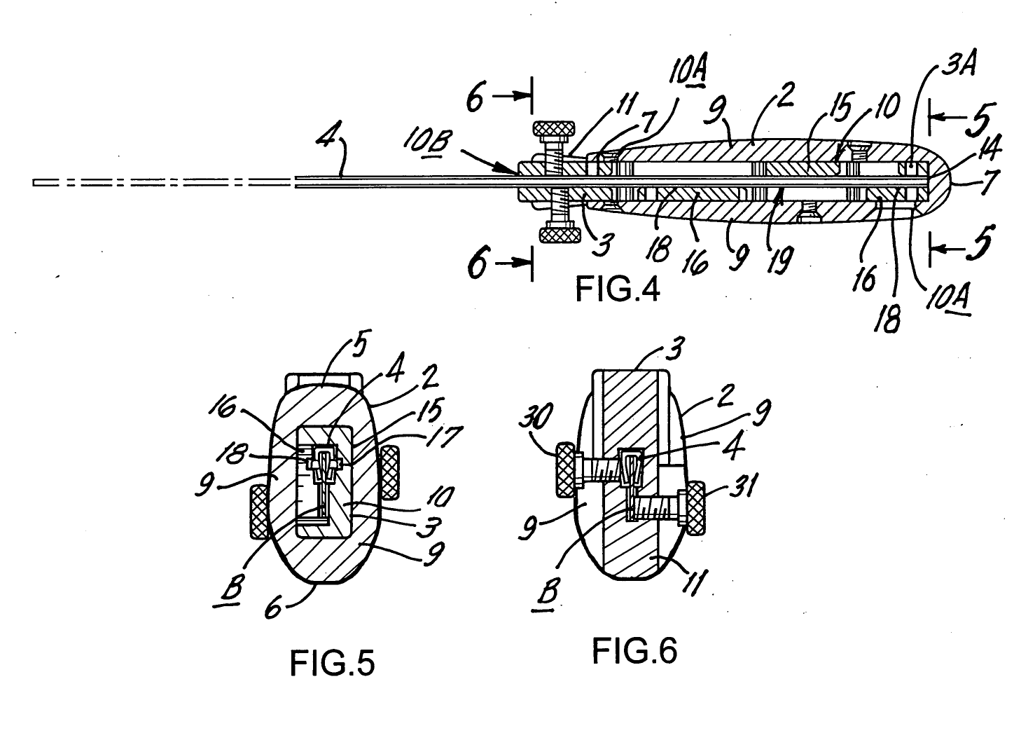

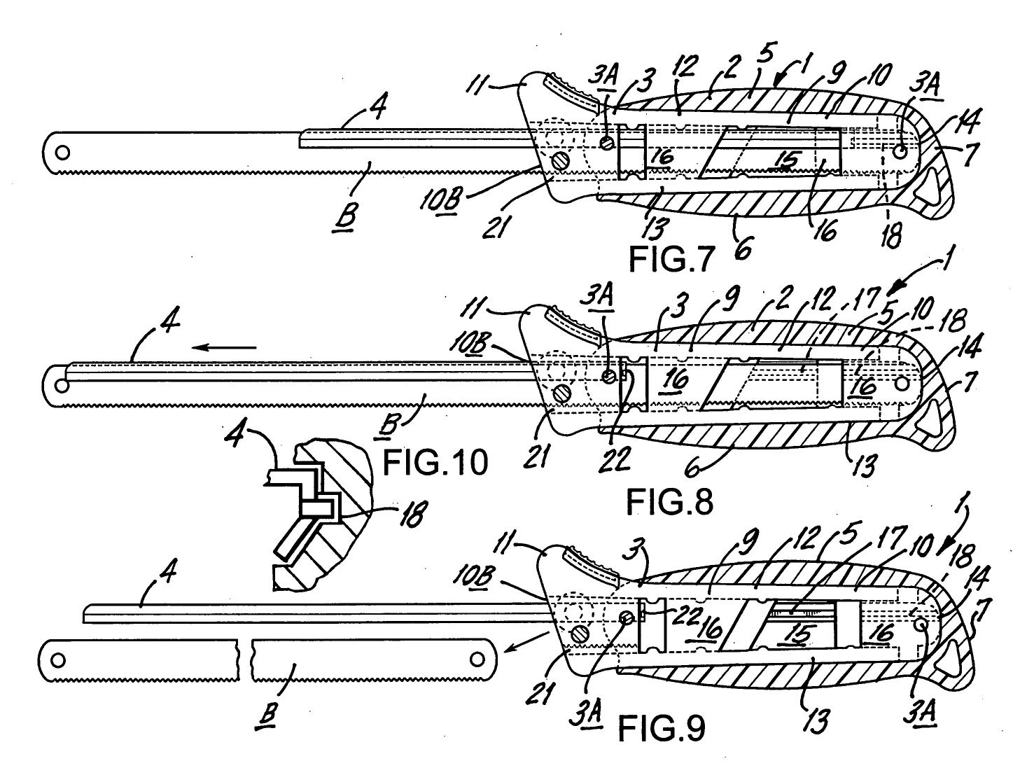

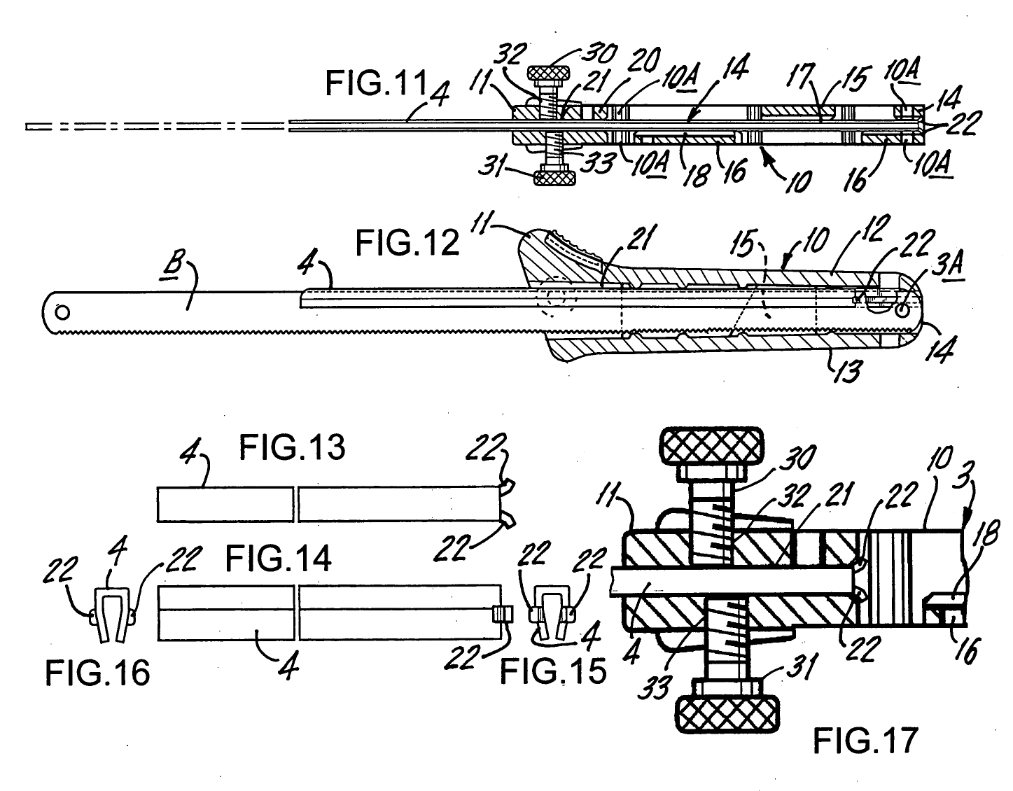

### DESCRIPTION

Referring to the drawings, the close quarter hacksaw 1 of the present invention comprises an outer hollow handle 2, an inner frame assembly 3 and a blade guide 4.

The hollow handle 2 comprises upper, lower and rear walls 5,6 and 7, respectively, opposed side walls 9 and a front open mouth 8 adapted to receive the inner frame assembly 3.

The inner frame assembly 3 comprises a rear blade-receiving portion 10 and a front lock portion 11 which are preferably integral (one piece) with each other. The blade-receiving portion 10 comprises upper, lower and rear walls 12, 13 and 14, respectively, and an open front mouth 10B. The blade receiving portion 10 is insertable in the open front mouth 8 of the handle 2 and is held in place therein by any well known fastening means (not shown) extending through openings 3A and 10A in the handle 2 and in the blade-receiving portion 10, respectively. A plurality of staggered (offset) partitions 15-16 extend between the upper and lower walls 12 and 13, respectively, of the blade receiving portion 10 on each side of its longitudinal center line to provide a longitudinal central passageway 19 to guide a blade B within the blade receiving portion 10.

Each partition 15 and 16 in the blade receiving portion 11 has a longitudinal side groove 17 and 18, respectively, which are opposite to and on the same plane with each other. The front lock portion 11 of the blade receiving portion 10 is in the form of a stop plug 20 having a channel 21 therein. The channel 21 is coextensive with the passageway 14 and with the open mouth 10B.

The blade guide 4 comprises a u-shaped body 25 having opposed legs 26 connected together by a base 27 with an open edge 28 opposite the base 27. The blade guide 4 has a pair of outwardly extending guide keys 22 at the rear. The blade guide 4 is slidably mounted within the passageway 19 and the channel 21 through the open front mouth 10B with the guide keys 22 inserted within the opposed side grooves 17-18 in the blade receiving portion. Hence, blade guide 4 is movable within the passageway 19 and the channel 21 with its guide keys 22 sliding in the opposed side grooves 17-18. Movement of the blade handle 4 is limited by the stop plug 20 at the front of the blade receiving portion 10. The guide keys 22 are wider than the channel 21 in stop plug 20 so that they will strike the stop plug 20 and are prevented from further movement. Hence, the blade guide 4 is moveable within the inner frame assembly 3 between the rear wall 7 and the stop plug 20 with the guide keys 22 and the stop plug 20 preventing any further forward movement of the blade guide 4. It will thus be noted that the blade guide 4 cannot be removed from the blade receiving portion 11.

The blade B is the usual form of hack saw blade and is mounted within the blade guide 4 and is moveable relative thereto between the legs 26 thereof. A pair of threadably mounted lock nuts 30 and 31 are provided on opposite sides of the stop plug 20 which are threadably mounted in openings 32 and 33 therein, respectively, located on opposite sides of the stop plug 20. The lock nuts 30 and 31 are planarly offset from each other (on different planes) so that one of the lock nuts 30 is at the same level as the blade guide 4 and the other lock nut 31 is at the same level as the blade B. By tightening the lock nut 30 the blade guide 4 is held in place in a particular position. By tightening the lock nut 31 the blade B is held in a place in a particular position on the blade guide 4.

In operation when it is desired to change the position of the blade guide 4 relative the blade receiving portion 10, the lock nut 30 is loosened. This permits the blade guide to move (with the blade B) within the blade receiving portion 10 in paragraph 19 and channel 21 with guide keys 22 sliding in grooves 17 and 18. When the desired position is achieved, the lock nut 30 is tightened to lock blade guide 4 with blade B in that particular position. When it is desired to remove the blade B or to adjust its position of the blade B relative the blade guide 4, the lock nut 31 is loosened and the blade B is moved relative to the blade guide 4 to the desired position. The lock nut 31 is then tightened to the lock the blade B in that particular position.

It will thus be seen that the present invention provides and improved close quarter hack saw which may be easily used for close quarter work in which the blade may be easily removed, in which the blade may be easily adjusted relative to the handle, which is simple to use and which is inexpensive to manufacture and assemble.

Accordingly, while only a few embodiments of the present invention have been shown and described, it is understood that many changes and modifications may be made thereunto without departing from the spirit and scope of the invention as defined in the appended claims.

The embodiments of the invention in which an exclusive property or privilege is claimed are defined as follows:

1. A hack saw comprising a blade receiving assembly and a blade guide assembly, said blade guide assembly being movable relative to said blade receiving assembly, said blade guide assembly adapted to receive a blade movably mounted therein, said blade receiving assembly having first lock means to lock said blade relative to the blade receiving assembly.

2. A hack saw as set forth in claim 1, wherein said blade receiving assembly is provided with a passageway to receive said blade guide assembly to permit the blade guide assembly to be moveable relative thereto.

3. A hack saw as set forth in claim 2, wherein a passageway comprises a plurality of spaced partitions.

4. A hack saw as set forth in claim 3, wherein said spaced partitions are offset from each other.

5. A hack saw as set forth in claim 4, wherein side grooves are provided in said offset opposed partitions.

6. A hack saw as set forth in claim 5, wherein a blade guide assembly is provided with keys and wherein said keys are adapted to enter said grooves and be slidable there within.

7. A hack saw as set forth in claim 6, wherein said blade receiving assembly is provided with a stop plug, said stop plug having a channel, said channel being narrower than distance between said key lock to prevent the blade receiving guide from moving out of the blade receiving assembly.

8. A hack saw as set forth in claim 8, wherein said grooves and said keys are on the same plane with each other.

9. A hack saw as set forth in claim 7, wherein said blade guide assembly is unshaped with a pair of spaced legs and wherein a blade is adapted to be received therein.

10. A hack saw as set forth in claim 8, wherein said blade protrudes beyond at least one of the legs of the blade guide assembly.

11. A hack saw as set forth in claim 1, wherein said blade receiving assembly has second lock means to lock a blade relative to the blade guide assembly.

12. A hack saw as set forth in claim 11, wherein the stop plugs of said blade receiving assembly are provided with lock means and wherein said first and second lock means are offset from each other in a planar direction.

13. A hack saw as set forth in claim 12, wherein said first lock means are adapted to strike the blade guide assembly in order to releasably hold it in place on said blade receiving assembly.

14. A hack saw as set forth in claim 13, wherein the second lock means is adapted to strike the blade to releasably lock it in place in said blade guide assembly.

15. A hack saw as set forth in claim 14, wherein said first and second lock means comprise threaded means threadably mounted in said stop plug.

16. A hack saw as set forth in claim 15, wherein a handle having an upper end is provided and wherein said blade receiving assembly is mounted within said handle.

17. A hack saw as set forth in claim 16, wherein said blade receiving assembly has a lock portion that protrudes beyond the open end of the handle and wherein said lock plug is mounted in said lock portion.

18. A hack saw comprising a blade receiving assembly and a blade guide assembly, said blade guide assembly being movable relative to said blade receiving assembly, said blade guide assembly adapted to receive a blade movably mounted therein, said blade receiving assembly having lock means to lock a blade relative to the blade guide assembly.

19. A hack saw as set forth in claim 18, wherein the stop plugs of said blade receiving assembly are provided with lock means and wherein said first and second lock means are offset from each other in a planar direction.

20. A hack saw as set forth in claim 19, wherein said first lock means are adapted to strike the blade guide assembly in order to releasably hold it in place on said blade receiving assembly.

21. A hack saw as set forth in claim 20, wherein the second lock means is adapted to strike the blade to releasably lock it in place in said blade guide assembly.

22. A hack saw as set forth in claim 21, wherein said first and second lock means comprise threaded means threadably mounted in said stop plug.

23. A hack saw as set forth in claim 22, wherein a handle having an upper end is provided and wherein said blade receiving assembly is mounted within said handle.

24. A hack saw as set forth in claim 23, wherein said blade receiving assembly has a lock portion that protrudes beyond the open end of the handle and wherein said lock plug is mounted in said lock portion.
